(19) United States
(12) Patent Application Publication
(10) Pub. No.: US 2023/0169513 A1
(43) Pub. Date: Jun. 1, 2023

(54) Management of an electronic wallet associated with a shared connected piece of equipment

(71) Applicant: Orange, Issy-Les-Moulineaux (FR)

(72) Inventors: Emmanuel Le Huerou, Chatillon Cedex (FR); François Toutain, Chatillon Cedex (FR)

(21) Appl. No.: 18/071,006

(22) Filed: Nov. 29, 2022

(30) Foreign Application Priority Data
Nov. 30, 2021 (FR) 2112766

(51) Int. Cl. G06Q 20/40; G06Q 20/36; G06Q 20/34

(52) U.S. Cl. CPC G06Q 20/405; G06Q 20/36; G06Q 20/351

(57) ABSTRACT

A method for managing an electronic wallet associated with a shared connected piece of equipment. The electronic wallet includes a plurality of virtual transaction cards. The method includes the following steps: determining a sequence for using at least two virtual transaction cards of the electronic wallet by analyzing features associated with the virtual transaction cards of the electronic wallet and/or according to an identification of the at least two users of the shared piece of equipment. Also provided are a management device implementing the method and connected and shared pieces of equipment such as a shared connected vehicle or a shared connected home.

### FIELD OF THE DISCLOSURE

The present disclosure relates to the management of an electronic wallet associated with a connected piece of equipment, with the electronic wallet comprising a plurality of virtual cards, vouchers or tickets.

More specifically, the present disclosure relates to determining sequences for using such virtual cards in a connected piece of equipment shared between several users. Such a shared connected piece of equipment is a connected vehicle or even a connected house, for example. A connected piece of equipment is understood to mean that the piece of equipment is capable of communicating with other external or internal pieces of equipment or devices in order to send and receive messages, commands or any other data.

### BACKGROUND

Connected vehicles are beginning to emerge and have the prospect of providing their occupants with different services outside of transportation and navigation. Indeed, it is contemplated that these vehicles, which have their own IT infrastructure, will be able to record personal information of the users of the vehicle. It is known, for example, that the information system of the vehicle knows the personal features of the positioning of the seat of the driver, of the rear-view mirror and other driver-related adaptations. Thus, when the driver is identified, their driving parameters are taken into account in order to adapt the driving position or other services that the information system can implement.

Vehicle information systems are also beginning to be contemplated that access a wallet of a user that stores a payment card that can be used, for example, for purchases such as petrol, electricity recharging or paying for parking. This is provided, for example, in the published patent application US 2021/008912, which describes storing a payment card in the information system of the car, which is selected when the driver is identified.

This system described in this case does not make provision for the possibility of the same user having several virtual payment cards or even several virtual cards used for different transactions, such as discount cards, subscription cards, prepaid cards for certain services, restaurant cards or any other means of obtaining a service.

The selection of such a virtual card or virtual ticket can considerably complicate the actions that the driver can take. Indeed, if they have to scroll through a list of cards to be selected each time a transaction has to be settled, this can prove to be dangerous within the context of driving a vehicle. Indeed, they may lose their concentration, choose the wrong card or simply lose time. However, any loss of concentration must be prevented in order to improve the safety of the driver and their passengers.

Similarly, the systems described in the prior art are not able to manage the existence of a plurality of transaction cards belonging to different users. Indeed, within a context of vehicle sharing, it is possible that the vehicle is shared by different persons from the same family, for example. These persons may use the shared vehicle individually or even as a group.

In this case, the computer system of the vehicle must be able to know which transaction means to use and thereby avoid any unnecessary manipulations by the users of the vehicle.

Within the context of a connected house or, more generally, a connected home, systems exist for managing these connected spaces that allow, for example, the home automation devices and the different digital services that can be used in these living spaces to be managed. The prior art does not make provision for the management of digital services or any other service requiring a transaction, when these living spaces are inhabited or used by a plurality of persons. However, the multi-user context is important for shared housing, for example, or for rental services, hotels or any other context of sharing a living space. The selection of one or more payment means adapted to this multi-user context can be a source of errors and conflicts between users when this selection is not assisted.

### SUMMARY

An exemplary aspect of the present disclosure improves the prior art.

To this end, an exemplary aspect of the disclosure relates to a method for managing an electronic wallet associated with a shared connected piece of equipment, the electronic wallet comprising a plurality of virtual transaction cards, the method comprising the following steps:
receiving a transaction request originating from a device for providing services or products;
determining a sequence for using at least two virtual transaction cards of the electronic wallet for the transaction request received by analyzing features associated with the virtual transaction cards of the electronic wallet and/or according to an identification of at least two users of the shared piece of equipment.

Thus, a sequence for using a plurality of virtual transaction cards is automatically determined by analysing features of the virtual transaction cards of the electronic wallet and/or according to the users of the shared piece of equipment, which allows, on the one hand, to facilitate the selection of the virtual cards to be used for this transaction and, on the other hand, to avoid selection errors. In an environment where the concentration of the user is important for their safety, for example, in a vehicle, this assisted determination is essential.

In one embodiment, determining a sequence takes further into account a transaction context on the basis of data extracted from the transaction request and/or of data originating from the shared piece of equipment.

Thus, combining both features associated with the virtual transaction cards of the electronic wallet and/or user identification information and transaction context information, allows to determine relevant transaction sequences that can be proposed to the users of the connected piece of equipment.

In one embodiment, identifying the at least two users of the shared piece of equipment comprises a default identification of the piece of equipment owner.

This embodiment is particularly suitable in the event of renting or loaning a connected piece of equipment in order to benefit from the virtual cards of the owner that are included in the electronic wallet associated with the piece of equipment.

In a particular embodiment, identifying the at least two users of the shared piece of equipment comprises identifying the persons present in the shared piece of equipment.

Determining the sequences for using the virtual cards is then carried out as a function of the persons present in the piece of equipment, which allows sequences to be obtained that are adapted to the transactions involving these persons present in the shared piece of equipment.

In one possible embodiment, the transaction request comprises transaction information data included in the following group:
categorization of the transaction;
amount of the transaction;
identity of the merchant with which the transaction is made.

This information is useful for determining a specific transaction context.

Similarly, in the case whereby the shared connected piece of equipment is a shared connected vehicle, the data originating from the shared vehicle that is useful for determining a specific transaction context is data included in the following group:
vehicle location data;
time data;
vehicle speed data.

In a particular embodiment, transaction rules involving the use of one or more virtual card(s) of the electronic wallet are stored in the electronic wallet associated with the shared connected piece of equipment.

Thus, certain transaction rules can be entered or learnt in order to take them into account when determining transaction sequences. These transaction rules allow the number of possible sequences to be proposed to the users of the connected piece of equipment to be limited in order to further facilitate user interactions.

According to one embodiment, the transaction rules are rules for prioritizing the use of the virtual cards stored according to a categorization of the transaction or according to an identification of the persons present in the piece of equipment.

A transaction rule also can be a division of an amount of the transaction between the persons identified as users of the shared piece of equipment.

These transaction rules thus allow the determination of the transaction sequences of the method for managing the electronic wallet to be refined.

In one embodiment, the sequence for using at least two virtual transaction cards is displayed or vocalized on a user interface of the shared piece of equipment with a confirmation request.

Thus, the users of the connected piece of equipment may or not confirm the one or more sequence(s) proposed by the management method. This step can be useful when several sequences are proposed or when there are no transaction rules for refining the determination of these sequences.

According to an advantageous embodiment, the transaction rules are updated following the confirmation or the non-confirmation of the sequence via the user interface.

Thus, the transaction rules stored in the electronic wallet are learnt and updated over time, which allows the determination of the transaction sequences to be refined.

An aspect of the present disclosure also relates to a device for managing an electronic wallet associated with a shared connected piece of equipment, the electronic wallet comprising a plurality of virtual transaction cards, the management device comprising a communication module, a memory and a processor capable of controlling the following steps:
receiving a transaction request originating from a device for providing services or products;
determining a sequence for using at least two virtual transaction cards of the electronic wallet for the transaction request received by analyzing features associated with the virtual transaction cards of the electronic wallet and/or according to an identification of at least two users of the shared piece of equipment.

An aspect of the present disclosure also relates to a connected vehicle comprising a management device as described, it relates to a device as described and included in a device for managing a shared connected home.

Finally, An aspect of the present disclosure relates to a processor-readable information medium, on which a computer program is stored that comprises instructions for executing the steps of the management method as described.

The device, the connected vehicle and the information medium have the same advantages as those described for the method they implement.

### BRIEF DESCRIPTION OF THE DRAWINGS

Further features and advantages will become more clearly apparent upon reading the following description of particular embodiments, which are provided by way of simple illustrative and non-limiting examples, and from the accompanying drawings, in which:

FIG. 1 illustrates a first example of the application of the method for managing an electronic wallet according to an exemplary aspect of the disclosure, associated with a shared piece of equipment of the connected vehicle type;

FIG. 2 illustrates a second example of the application of the method for managing an electronic wallet according to an exemplary aspect of the disclosure, associated with a shared piece of equipment of the connected home type;

FIG. 3 illustrates, in the form of a flow chart, an embodiment of the method for managing an electronic wallet according to an exemplary aspect of the disclosure;

FIG. 4a illustrates, in the form of a table, a first example of storing virtual cards in a digital wallet according to an exemplary aspect of the disclosure;

FIG. 4b illustrates, in the form of a table, a second example of storing virtual cards in a digital wallet according to an exemplary aspect of the disclosure.

### DETAILED DESCRIPTION OF EMBODIMENTS OF THE INVENTION

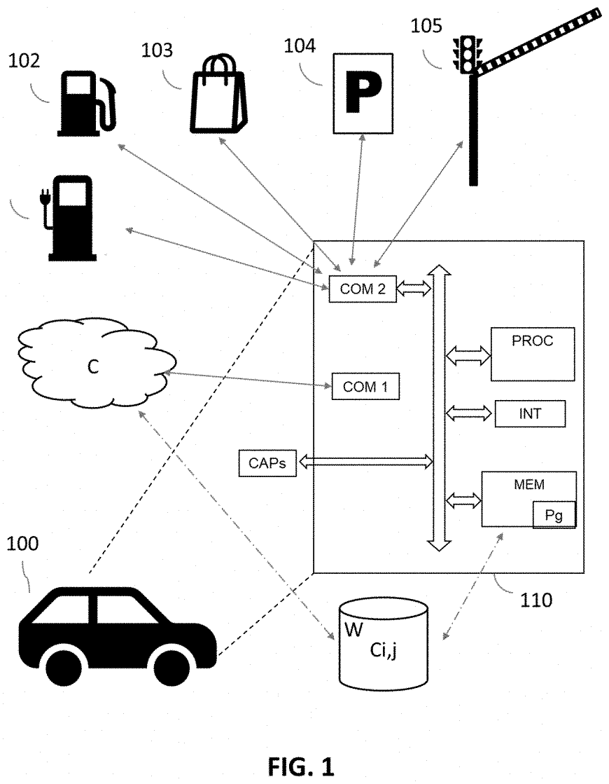

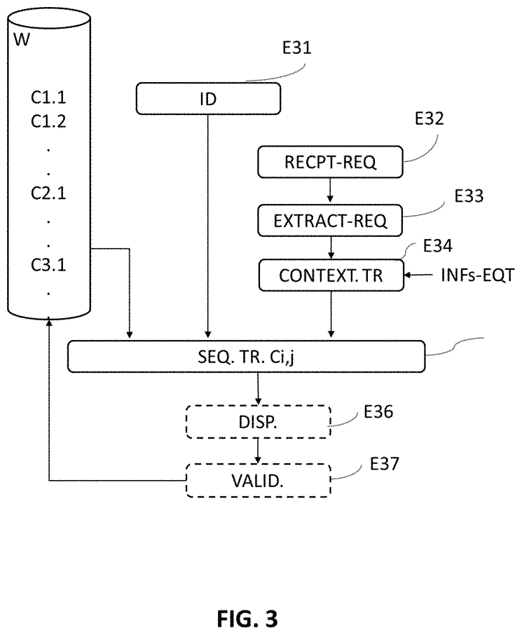

FIG. 1 illustrates a first example of the application of an exemplary aspect of the disclosure. In this example, a shared connected piece of equipment is a vehicle, denoted 100 in the figure. This vehicle comprises a computer system (110) particularly comprising a control module comprising a processor (PROC) configured to execute instructions of one or more computer program(s) (Pg) stored in a memory (MEM) of the computer system. Such a computer program comprises instructions for executing the steps of the method for managing the electronic wallet as described hereafter with reference to FIG. 3. This control module is able to manage the different services proposed to the driver or their passengers, such as, for example, navigation using GPS (Global Positioning System) type location tools, multimedia management for listening to music, the radio, or even management of communications via mobile terminals present in the vehicle. This system 110 comprises a user interface (INT), which can, for example, be in the form of a touch screen arranged on the dashboard of the vehicle, the interface can also provide voice recognition so that the occupants of the vehicle can interact with the computer system of the vehicle. The computer system can comprise or interact with sensors (CAPs) provided in the vehicle, such as, for example, cameras for viewing the immediate environment of the vehicle in front or behind, speed sensors, battery level detection for an electric vehicle or the fuel level, sensors for recognizing any presence in the vehicle, biometric sensors for identifying persons in the vehicle, etc.

The list is not exhaustive, many other sensors can be integrated into the vehicle described herein.

The computer system also comprises a communication module (COM2), for example, of the short- or medium-range wireless radio type, such as Bluetooth, Wi-Fi, DSRC (Dedicated Short Range Communications), C-V2X, and a communication module (COM 1) of the 4G or 5G cellular type.

The computer system of the vehicle comprises a SIM or eSIM card in a dedicated and secure memory in order to implement communications between the vehicle and different communications devices via the communications modules described above. This SIM or eSIM card allows a unique identifier to be obtained for the vehicle during these communications.

The short- or medium-range wireless communication module (COM 2) is adapted to send and receive transaction messages with different devices for providing goods or services located in the vicinity of the vehicle. Some examples of distributors of such goods or services are illustrated in FIG. 1. This can involve, for example, services for electrically recharging the vehicle (101), for providing fuel (102), or even drive-through food and beverage purchases (103), or even parking (104) or toll (105) services. Of course, many other provisions of goods or services can be contemplated herein.

In order to carry out transactions with these distributors or service providers, the computer system of the vehicle uses an electronic wallet (“e-wallet”), which also can be called digital wallet, in which several virtual transaction cards are stored. A virtual transaction card is understood to mean any type of payment card, digital token linked to a bank card, shopping vouchers, bank account debit order, prepaid tickets or any other virtualized transaction means. This electronic wallet can be completely or partly stored in the memory MEM of the computer system of the vehicle or it even can be stored in cloud type network servers (C) and be accessible by the computer system of the vehicle via the communication module (COM 1) of the computer system.

According to one embodiment of the disclosure, this electronic wallet can comprise a plurality of virtual transaction cards for the same user. It can also comprise different virtual cards for different users of the vehicle.

These virtual cards stored in this electronic wallet are associated with features specific to each of the virtual cards, such as purchase category features, authorized limit, features for restrictions on rights of use, geographical restriction, time restriction, confirmation mode or many other usage features.

The use of these different features will be described hereafter with reference to FIG. 3.

The method described hereafter and illustrated in FIG. 3 is, in the embodiment of FIG. 1, implemented by the processor of the computer system of the vehicle during a transaction made with a provider of goods or services as illustrated in this figure.

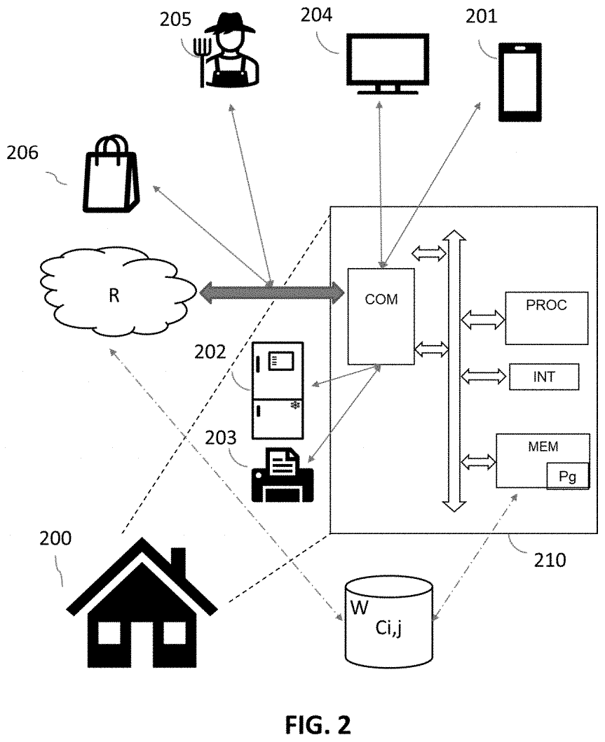

A second possible application of an exemplary aspect of the disclosure is illustrated in FIG. 2. The application context in this case is a shared and connected home (200), in which a local area network is provided to allow communications between the piece of equipment in the house and a management device (210) capable of managing the local area network. Such a management device (210) is, for example, a home gateway comprising a communication module (COM) comprising short- or medium-range wireless communication functions of the Wi-Fi, Bluetooth or Zigbee type for communicating with the piece of equipment or terminals of the local network. These pieces of equipment are illustrated, for example, in FIG. 2 and are of the mobile terminal (201), connected refrigerator (202) or even printer (203) type. Of course, many other pieces of equipment or devices in the home can be provided, as the wireless communication module of the management device 210 can exchange messages with the piece of equipment in the home and thus allow the functionality of these pieces of equipment to be controlled. The management device also comprises a control module comprising a processor (PROC) configured to execute instructions of one or more computer program(s) (Pg) stored in a memory (MEM). Such a computer program comprises instructions for executing the steps of the electronic wallet management method as described hereafter with reference to FIG. 3.

In one embodiment, the management device also can be integrated into a computer or smartphone type terminal.

The communication module (COM) of the management device also comprises a communication interface for communicating with an external network (R), for example, of the wired Ethernet type or even of the long-range wireless 4G or 5G type.

The management device thus can record or retrieve information from “cloud” type servers of the network R.

A user interface (INT) can be provided either on the management device or remotely, for example, on a screen located at the entrance to the home and accessible by all the occupants. An interface that already exists in the home, such as a television, for example, also can be used to interact with the management device. Similarly, the management device can be controlled by a dedicated management application accessible via the terminals of the occupants of the home.

Information dedicated to the operation of the home is stored in a memory MEM of the management device or in a memory of a server of the network R. This information includes an electronic wallet, in which several virtual transaction cards are stored. A virtual transaction card is understood to mean any type of payment card, digital token linked to a bank card, shopping voucher, bank account debit order, prepaid tickets or any other transaction means.

According to one embodiment of the disclosure, this electronic wallet can comprise several virtual transaction cards for the same occupant of the home. It can also comprise different virtual cards for different occupants.

These virtual cards stored in this electronic wallet are associated with features specific to each of the virtual cards, such as purchase category features, authorized limit, rights of use features, time restriction or even other usage features.

The use of these different features will be described hereafter with reference to FIG. 3.

The method described hereafter and illustrated in FIG. 3 is, in the embodiment of FIG. 2, implemented by the processor of the home management device during a transaction made with a provider of goods or services as illustrated in this figure.

Possible transactions with a connected and shared piece of equipment for the home are, for example, transactions for obtaining multimedia services (204), such as video on demand, games, access to streaming services or any other means for obtaining multimedia content that can be viewed on a television, a computer, a tablet or a mobile phone. Transactions for providing such multimedia services can be on a one-off or subscription basis. Such services can concern one or more occupant(s) of the house. Therefore, the payment for such a service must be adapted to the relevant persons.

Another type of transaction can be, for example, orders for miscellaneous supplies (206) for the occupants of the house, such as food purchases or meal delivery requests. Some orders can be triggered automatically by a connected refrigerator (202), which takes an inventory of its contents and orders certain food items as soon as the quantity is insufficient. It can involve supplies such as ink cartridges or paper for a printer. Again, the sensors (203) of the printer can send order information for these supplies to the home management device when necessary.

Other transactions can be provided, such as, for example, orders for gardening services (205) or cleaning services, the costs of which are to be shared among the occupants of the house.

Of course, many other provisions of goods or services can be contemplated herein.

The steps implemented by the method for managing an electronic wallet according to one embodiment of the disclosure will now be described. These steps are illustrated in the form of a flowchart in FIG. 3.

During a step E31, the users of the shared connected piece of equipment are identified.

The identifiers of the users of the piece of equipment are, in one embodiment, previously stored in a memory of the computer system of the connected piece of equipment, for example, in the digital wallet of the piece of equipment. The identification step then involves reading the identifiers thus stored.

In a particular embodiment, the persons present in the shared connected piece of equipment are identified.

In the case of a piece of equipment such as a connected vehicle, this identification step can be carried out by presence sensors provided in the vehicles and that detect how many persons are sitting in the vehicle. This type of detection allows the number of persons present to be known. Biometric sensors can be integrated into the vehicle for identifying the persons present. This can involve, for example, cameras provided in the vehicle that implement facial recognition of the vehicle occupants or even fingerprint readers provided in the vehicle. Identification also can be carried out by detecting any mobile phones present in the vehicle, with the mobile phones being associated with the persons present in the vehicle. This detection is carried out, for example, by the computer system of the vehicle, which searches for a Bluetooth piece of equipment present in the passenger compartment. This detection correlated with the detection of persons present in the vehicle provides the possibility of knowing whether all the persons present have been identified. Other means for identifying persons can be provided in the vehicle. As these means are known, they will not be described herein.

In a particular embodiment, the owner or manager of the vehicle is identified by default in the computer system of the vehicle, even if they are not present in the vehicle. Thus, the transaction means of this owner can be used for certain transactions and according to predetermined conditions.

In the case of a connected piece of equipment such as a home, in a particular embodiment, the persons present in the home are identified. This step of identifying the persons present in the home can be carried out by biometric sensors, such as a camera at the entrance of the home, for example, provided in the house and that are activated as soon as a person enters the home. Any mobile phones associated with the persons also can be detected either by searching for Wi-Fi appliances or Bluetooth appliances inside the house and identified beforehand by the home management device. The identification of the usual occupants of the house also can be stored by default in the house management device, so that certain transaction means of the occupants can be used even if they are not present in the home and according to predetermined conditions.

In step E32, the communication module of the connected shared piece of equipment receives a transaction request for the provision of a good or service, by a device providing such a good or service. This request is received in order to follow up on the initiation of a transaction, for example, when recharging a vehicle within the context of FIG. 1, when passing through a toll or even when ordering a meal at a drive-through.

The initialization of a transaction is implemented, for example, when the vehicle approaches a toll terminal, with a communication channel then being securely established in order to carry out a contactless transaction between the terminal and the computer system of the vehicle. Similarly, when the user of the vehicle plugs their vehicle into a recharging point, a secure communication channel is established so that a contactless payment can be made when the user has finished recharging their vehicle. The establishment of such a communication or pairing channel for a contactless transaction is conventional and will not be described further herein. In a particular embodiment, the establishment of such a communication channel is executed autonomously by the connected vehicle, as described in document FR 2106702, which is incorporated in this description for reference purposes.

For the case of a connected house as illustrated in FIG. 2, the transaction request received from the device for providing services or products can be a payment request from the food products provider in order to follow up on an order made by one of the occupants of the home via their mobile phone, for example, and an application dedicated to the management of the home and using the electronic wallet associated with the home. This order also can be carried out automatically by the connected refrigerator. A transaction request also can be a payment request for a subscription to the streaming service originating from a server managing this service following the activation of the service by one of the occupants of the home or even automatically in order to renew a subscription, for example. Many other orders and payment requests to be honored within a home can be made.

The transaction request received from the device for providing services or products is, for example, a SEPA RTP (Single Euro Payments Area Request to Pay) type payment request or a PayPal® type request or any other type of payment request.

This transaction request includes certain information concerning the current transaction, for example, the amount of the transaction, the categorization of the purchases or the service rendered, the content or the quantity of the goods provided or even the name of the provider of the service or of the goods, the date, etc.

In step E33, at least some of this information present in the transaction request is extracted.

Depending on this extracted information and also on information specific to the shared connected piece of equipment (INFs-EQT), a step of determining a transaction context is carried out in step E34.

In the case of a piece of equipment of the vehicle type, some information known from the computer system of the vehicle is used. This can be, for example, information such as the location of the vehicle via the GPS system of the vehicle, the time, the date or even the speed of the vehicle.

In the case of a piece of equipment of the home type, information known from the home management device is used. This information is, for example, the date, the time, a notification message concerning the level of consumption of provisions for appliances such as the refrigerator, the printer, the expiry dates of subscriptions taken out with certain service providers, etc.

Analyzing the data collected thus allows a transaction context to be determined. Indeed, in the example of a vehicle application, the information extracted from the transaction request concerning the name of the merchant (for example, electricity provider F1 for the vehicle), the information originating from the computer system of the vehicle, such as the charging level of the vehicle, the date and time, can be used, for example, to determine that a transaction for electrically recharging the vehicle is in progress on a Sunday at 5 p.m. at the provider F1.

The information extracted from the transaction request could be, in another example, the name of a take-out provider, the amount of the transaction and the address of the provider. The information originating from the computer system of the vehicle is, for example, the location of the vehicle, the fact that the vehicle is travelling at a speed V and the time. Thus, the analysis of this data can be used to determine that the transaction relates to the purchase of a take-out meal from a provider located 1 hour away and that the vehicle is on its way and therefore moving toward this provider.

Similarly, in the example of a home application, on the basis of data extracted from the transaction request, such as, for example, the name of the service provider (pizza delivery company P1), the number of pizzas ordered and the amount, and on the basis of data originating from the home management device, such as the date and time, the transaction context can be determined. The analysis of this data can be used to determine that the transaction relates to a delivery of 2 pizzas, for a price of €30.00, ordered from the provider P1, on Tuesday 23 November at 8 p.m.

In another example of a transaction for a home, an order for ink cartridges is initiated, for example, with an ink cartridge provider. The data extracted from the transaction request is, for example, the amount of the order, the number of cartridges, the date and the name of the provider E. The information provided by the home management device is, for example, the date, the time and the notification message sent by the connected printer that detected a lack of products. The analysis of this data can be used to determine that the transaction relates to an order for ink cartridges from the provider E and that the order was initiated by a notification message from the printer.

This context information and the identification information of the users of the shared piece of equipment allows, in one embodiment, on the basis of the virtual transaction cards stored in the electronic wallet, at least one sequence for using these cards to be determined in order to honor the received transaction request.

This step of determining a sequence for using at least two virtual transaction cards is carried out at E35 by analyzing features associated with the virtual transaction cards of the electronic wallet and/or according to the identification of the users of the shared piece of equipment. In an embodiment, the determined transaction context help at determining the sequence.

A plurality of virtual transaction cards is stored in the electronic wallet W. A virtual transaction card is understood to be any type of payment means, such as a digital token linked to a bank card, a shopping voucher, a bank account debit order, prepaid tickets or any other transaction means. These virtual transaction cards were previously stored by the one or more user(s) of the connected piece of equipment in association with the identity of the user. To this end, the user registers the identifiers representing the card that will allow the digital token or the payment or credit features needed for paying for the service or goods to be retrieved either from an associated banking service or even from the organization managing the card or the shopping voucher. These exchanges with the banking services or other organizations managing virtual transaction cards are conventionally carried out by a communication network and via dedicated communication means on the piece of equipment or on another terminal of a user. They will not be described in further detail herein.

These virtual transaction cards stored in the electronic wallet are associated with their own features. These features are, for example, features for categorizing the use of this card (such as restaurant cards, electric recharging cards), the brand of use (brand name of the fuel provider, restaurant brand name, etc.), the authorized payment limit, the associated right of use (delegation to a certain person, professional use only), the confirmation mode (code to be entered, voice message or no confirmation required), etc.

In addition to these associated features, which are stored as metadata associated with the card identifiers, the user can also enter their own features for using the card. For example, they can specify that such a card is to be used only on weekdays and another is to be used only on weekends, they can specify that such a card can be used by a certain person and for an associated maximum amount. They can also associate a purchase category with the cards they register.

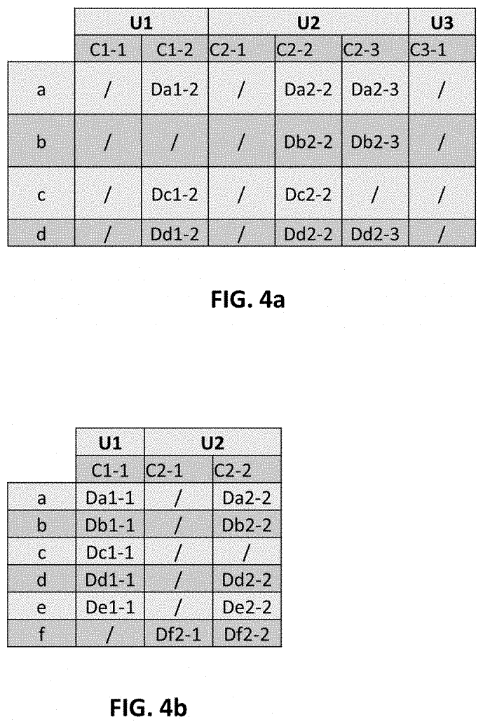

The storage of these features is illustrated in FIGS. 4a and 4b in the form of tables. In FIG. 4a, the table lists, for users U1, U2 or U3, the virtual transaction cards C1-1 and C1-2 for U1, C2-1, C2-2 and C2-3 for U2 and C3-1 for U3.

Associated features a, b, c, d, are then listed for each card, such as, for example, the category of the service or goods (a) (for example, food, restaurant, petrol, electric recharging, toll, office supplies, etc.) defined by a data item (Da) indicating the possible categories for this card, in the case whereby the card in question is dedicated to one or more categories (Da1-2 for card C1-2). Some cards may not have an associated category, in which case any type of category is authorized, which is illustrated by the fact that no data is associated with this row. A data item specifying that any category is authorized also can be indicated in an alternative embodiment.

Another feature is, for example, a limit feature for a possible amount for this card (b), the value of this limit is then defined by an associated data item, if applicable (Db2-2 for card C2-2). Again, some cards do not have an associated limit.

A “right of use” type feature (c) of the card also can be listed with an associated data item (Dc1-2 for card C1-2), which can correspond to a limitation of use dependent on the presence of U1 in the piece of equipment.

Finally, a feature (d) linked to the calendar can be listed and can be defined by a data item (Dd) for the use of the card on, for example, certain days of the week, or times of the day or even certain periods of the year. Again, this feature may not be defined for all the cards.

FIG. 4b illustrates another table storing one card C1-1 for user U1 and two cards C2-1 and C2-2 for user U2. The features a, b, c, d, e and f listed in this case are, for example, for a, b, c, d, the same as those described for FIG. 4a. The associated data Da1-1, Db1-1, Dc1-1 and Dd1-1 are stored for card C1-1 and the data Da2-2, Db2-2, Dd2-2 are stored for card C2-2. Another feature (e) is provided in this case. It relates to the geographical location, for example. The data associated with this feature for card C1-1 is, for example, data indicating that this card only operates in France (De1-1), for card C2-2, this data item (De2-2) can be a data item indicating operation in Europe.

Another feature (f) is in this case, for example, a feature of the confirmation mode of the card. For example, the data item Df2-1 associated with card C2-1 can be a confirmation by a voice message and the data item Df2-2 can be a confirmation by a code. The card C1-1 has no confirmation data, which in this case means that there is no confirmation step for this card.

These lists of features are not exhaustive. Other features of the use of these cards clearly can be listed in the same way. Similarly, the number of registered users and the number of cards clearly can be different. This data can be stored in table form as illustrated in FIGS. 4a and 4b, but clearly can be stored in different forms, for example, in tree form or in list form.

In step E35 illustrated in FIG. 3, at least one sequence for using at least one virtual transaction card of the transaction electronic wallet is determined by analyzing features associated with the virtual transaction cards of the electronic wallet, the determined transaction context and the identification of the at least one user of the shared piece of equipment.

In an application case illustrated in FIG. 1, on a piece of equipment of the connected vehicle type, the situation is considered, by way of a first example, whereby three persons are in the vehicle. These three persons have virtual transaction cards stored in the electronic wallet associated with the vehicle, as illustrated in FIG. 4a, for example. These three persons were identified in step E31. For this example, a transaction is in progress to order a take-out meal from a specific provider denoted R1. The data relating to this transaction was extracted from the transaction request in step E33 (amount, provider, category), and the transaction context was defined in step E34 with the additional information originating from the computer system of the vehicle (for example, the time). The transaction is determined as being a transaction with the provider R1, the purchase category is catering, for an amount of €30.00, on a Sunday at 8 p.m. In order to determine a transaction rule adapted to this specific transaction, the features of the virtual cards are analyzed in step E35. A match is made between the data of features of the transaction cards and the determined transaction context data and/or the lists of persons present. When one or more matches is/are found, the relevant cards are selected in order to determine a suitable sequence for the transaction corresponding to the received request.

These features show that card C1-2 of the user U1 can only be used on weekdays (data item Dd1-2=Monday to Friday) and for a category (Da1-2=electric recharging, toll and parking) different from that of the current transaction. Therefore, this card cannot be used for this transaction. Card C1-1, however, can be used for any type of category, without the restriction of rights and at any time (no associated data for category d). Therefore, it can be used. Similarly, cards C2-1 and C3-1 can be used for any type of category and at any time. Therefore, they also can be used for this transaction.

Card C2-2 is a restaurant card (Da2-2=restaurant, food) with a €19.00 limit (db2-2=€19.00) but cannot be used on Sundays (Dd2-2=every day of the week except Sundays and public holidays), it therefore cannot be used in this case.

Card C2-3 is a shopping voucher from provider R1 (Da2-3=provider R1) for an amount of €10.00 (db2-3=€10.00) and with a use-by date (Dd2-3=until 31 Dec. 2021) after the date of the current transaction. It therefore can be used for this transaction.

Thus, several sequences for using virtual cards, which also can be called transaction sequences, can be determined. A first transaction sequence can be, for example, to use only card C1-1. A second transaction sequence can be to use card C2-3 for an amount of €10.00 and then to use card C1-1. A third transaction sequence can be to use cards C1-1, C2-1 and C3-1 for an amount corresponding to the transaction amount divided by 3 (in this case €30.00/3=€10.00). A fourth transaction sequence also can be to use card C2-3 for an amount of €10.00 and then to use cards C1-1 and C2-1 with an amount corresponding to the remaining transaction amount, divided by 2 (in this case (€30.00−€10.00)/2=€10.00).

In one embodiment, these different transaction sequences are proposed to the users of the piece of equipment in step E36 of FIG. 3, for example, by being displayed on the vehicle dashboard, or even by a vocalized proposal, so that they can confirm their preferred choice. The display thus provides an interface for confirming or not confirming the proposed determination, by a touch or voice interaction. Thus, depending on the choice selected by the occupants of the vehicle, the computer system stores this confirmation information in the electronic wallet in order to enhance the information associated with the virtual cards. Transaction rules involving one or more virtual card(s) in the electronic wallet thus can be stored in addition to the data linked to the features of the cards. Learning is thus carried out over time and as a function of the repeated use of the same confirmations for similar situations. For example, if the choice of the fourth sequence is confirmed, then the computer system learns that, in the case where users 1, 2 and 3 are in the vehicle and for a catering expense, the cards of users 1 and 2 are used.

This learning is carried out, for example, by applying a weighting to the determined sequences. The higher the value of the weighting, the higher the priority of the sequence. Thus, when a sequence is confirmed by the user, the weight associated with this sequence is increased. The weighted sequence is thus stored as a transaction rule. These transaction rules are stored in addition to the data linked to the features of the virtual cards in order to reduce the number of proposals of transaction sequences determined by the system for the subsequent transactions. These transaction rules therefore can be learnt but also can be entered by the users, for example, when storing virtual cards in the electronic wallet. These learnt or entered rules can be, for example, rules for prioritizing the use of certain cards according to the categorization of the transaction (for example, prioritizing shopping vouchers or the restaurant card before any other card for food transactions), or depending on the persons present in the vehicle or the piece of equipment (for example, if U1 and U2 are present: prioritizing the cards of U1). Thus, determining transaction sequences also takes into account these transaction rules learnt or entered into the electronic wallet associated with the vehicle.

In a second example of application in a vehicle, a transaction can involve electrically recharging the vehicle. The information extracted from the transaction request in step E33 is, for example, the name of the electricity provider F1 for the vehicle, the amount of the transaction, the information originating from the computer system of the vehicle is, for example, the vehicle charging level, which is 100% once recharging is complete, the date and the time. This information is used to determine that the transaction is a transaction for electrically recharging the vehicle, on a Sunday at 5 p.m., at the provider F1.

In order to determine a transaction rule adapted to this specific transaction, the features of the virtual cards are analyzed in step E35. A match is made between the data of features of the transaction cards and the determined transaction context data and/or the lists of persons present. When one or more matches is/are found, the relevant cards are selected in order to determine a suitable sequence for the transaction corresponding to the received request.

Thus, in this example, the category of the transaction means that cards C2-2, C2-3 can be dispensed with since the data associated with the “a” category feature does not correspond to the electric recharging category. Similarly, the transaction data “Sunday 5 p.m.” does not correspond to the calendar feature data of card C1-2 (Dd1-2=Monday to Friday). Thus, only cards C1-1, C2-2 and C3-1 can be used. A sequence for using these cards is, for example, to use the three cards with an amount divided over these three cards. Another sequence is to use only the cards of U1 and U2 with a divided amount or even to use only one card, of U1 or of U2 or of U3.

A transaction rule previously stored either by the users, or after a learning phase for the use of these cards of the electronic wallet, gives priority to the use of, for example, card C1-1 for the “electric recharging” category, even in the presence of users U1 and U3. In this case, only one sequence is proposed on the vehicle interface for confirmation, namely that which proposes the use of card C1-1 for this transaction. Indeed, in the case whereby a weighting is applied to the sequences stored in the transaction rules, one embodiment involves displaying only the sequence with the highest weight. In an alternative embodiment, the difference in weight between two sequences can be computed and a comparison is made with a threshold. In this alternative embodiment, only the sequence with a weight difference greater than the threshold is proposed. If the weight difference is not high enough, then both sequences are proposed to the user.

In a third example, the vehicle is a rental vehicle. The electronic wallet, in this example, is illustrated in FIG. 4b. This electronic wallet associated with the vehicle by default comprises a virtual transaction card (C1-1) associated with the lessor (U1) of the vehicle. This card is associated with features, for example, possible transaction categories (Da1-1=petrol, toll), limit (db1-1=€50.00), rights of use (Dc1-1=right for U2 during the rental period), with the rental period being defined by the data item (Dd1-1) associated with the calendar feature d. A further geographical location (e) feature also can be provided. A data item De1-1 for the country of use of the card is then provided.

Finally, a confirmation mode feature (f) is also provided. A data item Df2-1 associated with card C2-1 indicating that an oral confirmation must be carried out and a data item Df2-2 associated with card C2-2 indicating that a confirmation by entering a code is required.

The features of card C1-1 can be configured by the vehicle lessor in accordance with the rental contract intended and taken out for this vehicle.

The vehicle lessee stores these transaction cards in the electronic wallet associated with the vehicle in order to be able to easily settle any expenses they may have with this vehicle during the rental period. Their cards will be removed from the electronic wallet after the rental period, either by themselves or automatically at the end of the rental period. Thus, in the example illustrated herein with reference to FIG. 4b, the lessee has stored 2 virtual cards, their usual payment card (C2-1) applicable for any type of transaction and a restaurant card (C2-2) associated with category data (Da2-2=restaurant, food), a limit (db2-2=€19.00), a calendar (Dd2-2=every day except Sunday and public holidays), location (De2-2=only in Europe) and confirmation mode (Df2-2=by code).

Thus, when the car lessee visits a petrol station, the data relating to this transaction was extracted from the transaction request in step E33 (for example, the amount of the transaction and the name of the provider), and the transaction context was defined in step E34 with the data originating from the vehicle (date, time, location). The transaction context is then defined as being the provision of petrol, for an amount of €60.00, in France and at the provider E1, on Monday 29 November at 12 p.m. In order to determine a transaction rule adapted to this specific transaction, the features of the virtual cards are analyzed taking into account the features described in FIG. 4b. A match is made between the features data of the transaction card and the determined transaction context data and/or the lists of persons present. When one or more matches is/are found, the relevant cards are selected in order to determine a suitable sequence for the transaction corresponding to the received request.

Thus, for this transaction context, the analysis of the features of the transaction cards stored in the electronic wallet shows that card C1-1 of the lessor can be used for this type of purchase and in this country, but only for an amount of €50.00, and that card C2-2 of the lessee U2 cannot be used because it does not relate to this transaction category. However, card C2-1 can be used.

Determining a first transaction sequence can involve using card C1-1 for an amount of € 50.00 and then using card C2-1 for the remaining amount. Another transaction sequence can involve using only card C2-1 for this transaction.

These two proposed sequences can be displayed for the driver renting the car for confirmation. The system can also automatically opt for the first solution if a transaction rule already defined and learnt by the system is instructed to grant priority to the virtual card of the lessor.

In another example, the information extracted from the transaction request is the name of a take-out provider, the amount of the transaction and the address of this provider. The information originating from the computer system of the vehicle is, for example, the time, the location of the vehicle and the fact that the vehicle is travelling at a speed V. Analyzing this data means it is possible to determine that the transaction relates to a purchase of a take-out meal from a provider located 1 hour away, for an amount of €18.00 and that the vehicle is on route and thus moving toward this provider.

The step of determining a sequence for using the cards of the electronic wallet takes into account both the determined context, the persons present in the vehicle and the features of the stored cards. In this example, the persons identified in the vehicle are, for example, the user U1, as well as a user U4 not known to the computer system of the vehicle. The category of the transaction does not allow the use of card C1-1, with the associated feature data being only for a petrol, toll category. Cards C2-1 and C2-2 can be used since they have a data item from a compatible category. The amount is below the limit of card C2-2. However, the context indicating that the vehicle is moving suggests that it is preferable to use a card that does not require confirmation using a code, so as not to distract the driver of the car. Thus, card C2-2, which requires confirmation using a code, is not preferred. Only card C2-1 is then proposed, with the confirmation mode being carried out by a voice command. The sequence proposed to the user is therefore that using card C2-1 for this transaction.

A first embodiment for application in a home will now be described, as illustrated in FIG. 2. The electronic wallet associated with the home is, for example, as shown in FIG. 4a, where the cards of users U1, U2, and U3, occupants of the home, are stored. For this embodiment, card C1-2 has a data item linked to the rights of use that are restricted in this case due to the fact that U1 must be present (Dc1-2=if U1 is present), similarly the data item Dc2-2 provides a usage restriction to the presence of U2 in the home for card C2-2. The category data item (Da1-2) of card C1-2 equates to the “multimedia” category, the category data item (Da2-2) of card C2-2 equates to the “food” category and the category data item (Da2-3) of card C2-3 equates to the “pizza provider P1” category. The limit data item for card C2-2 is db2-2=€19.00 and that of card C2-3 is db2-3=€30.00.

Finally, the calendar data item for card C1-2, Dd1-2, equates to a use-by date limit “until 31 Dec. 2021”, that for card C2-2 equates to specific days Dd2-2=“every day except Sunday and public holidays” and that for card C2-3 equates to a use-by date limit Dd2-3=“until 30 Nov. 2021”. Thus, a possible transaction in this case is a request for a home delivery of meals. The data extracted from the transaction request is, for example, the name of the service provider (pizza delivery company P1), the number of pizzas ordered and the amount (€30.00). The data originating from the home management device is, for example, the date and time. On the basis of this data, the transaction context can be determined. Analyzing these data means that it is possible to determine that the transaction relates to a delivery of 2 pizzas, for an amount of €30.00, ordered from the provider P1, on Tuesday 23 November at 8 p.m.

The persons present in the home at this time were identified in step E31. Users U2 and U3 were detected as being present. In order to determine a suitable transaction sequence for this specific transaction, the features of the virtual cards are analyzed taking into account the features of these cards. The feature data of the transaction cards and the determined transaction context data and/or the lists of persons present are matched. When one or more matches is/are found, the relevant cards are selected in order to determine a suitable sequence for the transaction corresponding to the received request. For this example, since only users U2 and U3 are present, the cards of these two users are considered in order to determine the possible transaction sequences. Indeed, the transaction cards of U1 do not permit use if U1 is not present in the home. The category data specified for cards C2-2 and C2-3 is compatible with the transaction, as is the calendar data of cards C2-2 and C2-3. The limit data for card C2-2 is less than the total amount but is compatible with the amount divided by two and the limit data for card C2-3 is compatible with the total amount of the transaction.

Thus, a possible transaction sequence is, for example, the use of card C2-2 and of card C3-1 for an amount divided by 2 (€30.00/2=€15.00) or even the use of cards C2-3 and C3-1 for an amount of €15.00 for each of the cards. These two sequences are proposed to the users present in the home, for example, on the interface of their mobile phone, so that they confirm this proposed sequence. Depending on their selection, the home management device learns that the confirmed transaction sequence can be stored as a transaction rule for future use in order to optimize the sequence proposals for future transactions.

In another example of a transaction for a home, an order for ink cartridges is initiated, for example, with an ink cartridge provider. The data extracted from the transaction request is, for example, the amount of the order, the number of cartridges, the date and the name of the provider E. The information provided by the home management device is, for example, the date, the time and the notification message sent by the connected printer that detected a lack of products. Analyzing this data means that it is possible to determine that the transaction relates to an order for ink cartridges from provider E and that the order was initiated by a notification message from the printer. The identification of the users of the home in this case corresponds to the occupants as stored in the electronic wallet, i.e., in this case, in the case of a wallet as illustrated in FIG. 4a, the users U1, U2 and U3. Indeed, one of the transaction rules stored in the wallet in this case is the fact that a supply expense for the printer relates to all the occupants of the house and that the expense therefore needs to be divided by the number of occupants. A possible sequence for using cards then involves, for example, using cards C1-1, C2-1 and C3-1 for an amount divided by 3. The other cards do not relate to the target category and therefore cannot be used.

Numerous examples thus can be used to implement the method described in FIG. 3 according to one or more aspects of the present disclosure.

Although the present disclosure has been described with reference to one or more examples, workers skilled in the art will recognize that changes may be made in form and detail without departing from the scope of the disclosure and/or the appended claims.

What is claimed is:

1. A method for managing an electronic wallet associated with a shared connected piece of equipment, the electronic wallet comprising a plurality of virtual transaction cards, the method being implemented by a managing device and comprising:
receiving a transaction request originating from a device for providing services or products; and
determining a sequence for using at least two virtual transaction cards of the electronic wallet for the transaction request received by analyzing features associated with the virtual transaction cards of the electronic wallet and/or according to an identification of at least two users of the shared piece of equipment.

2. The method according to claim 1, wherein determining the sequence takes further into account a transaction context on the basis of data extracted from the transaction request and/or of data originating from the shared connected piece of equipment

3. The method according to claim 1, wherein identifying the at least two users of the shared connected piece of equipment comprises identifying persons present in the shared connected piece of equipment.

4. The method according to claim 1, wherein the transaction request comprises transaction information data included in the group consisting of:
categorization of the transaction;
amount of the transaction;
identity of the merchant with which the transaction is made.

5. The method according to claim 2, wherein the shared connected piece of equipment is a shared connected vehicle and wherein the data originating from the shared connected vehicle is data included in the group consisting of:
vehicle location data;
time data;
vehicle speed data.

6. The method according to claim 1, wherein transaction rules involving use of one or more of the virtual transaction card(s) of the electronic wallet are stored in the electronic wallet associated with the shared connected piece of equipment.

7. The method according to claim 6, wherein the transaction rules are rules for prioritizing the use of the stored virtual transaction cards according to a categorization of the transaction or according to an identification of persons present in the piece of equipment.

8. The method according to claim 6, wherein at least one of the transaction rules is a division of an amount of a transaction between identified persons using the shared connected piece of equipment.

9. The method according to claim 1, wherein the sequence is displayed or vocalized on a user interface of the shared connected piece of equipment with a confirmation request.

10. The method according to claim 9, wherein transaction rules involving use of one or more of the virtual transaction card(s) of the electronic wallet are stored in the electronic wallet associated with the shared connected piece of equipment, and wherein the transaction rules are updated following a confirmation or a non-confirmation of the sequence via the user interface.

11. A management device for managing an electronic wallet associated with a shared connected piece of equipment, the electronic wallet comprising a plurality of virtual transaction cards, the management device comprising:
a communication module, and
a memory and a processor configured to control the following steps:
receiving a transaction request originating from a device for providing services or products; and
determining a sequence for using at least two virtual transaction cards of the electronic wallet for the transaction request received by analyzing features associated with the virtual transaction cards of the electronic wallet and/or according to an identification of the at least two users of the shared connected piece of equipment.

12. A connected vehicle comprising the management device according to claim 11.

13. The management device according to claim 11, wherein the management device is included in a device for managing a shared connected home.

14. A non-transitory computer readable storage medium, on which a computer program is stored that comprises instructions for executing a management method for managing an electronic wallet associated with a shared connected piece of equipment, when the instructions are executed by a processor of a management device, the electronic wallet comprising a plurality of virtual transaction cards, and the method comprising:
receiving a transaction request originating from a device for providing services or products; and
determining a sequence for using at least two virtual transaction cards of the electronic wallet for the transaction request received by analyzing features associated with the virtual transaction cards of the electronic wallet and/or according to an identification of at least two users of the shared piece of equipment.
